(19) United States
(12) Patent Application Publication
(10) Pub. No.: US 2008/0232789 A1
(43) Pub. Date: Sep. 25, 2008

(54) Camera

(76) Inventor: Hiroshi Otsuka, Saitama-shi (JP)

Correspondence Address: JACOBSON HOLMAN PLLC, 400 SEVENTH STREET N.W., SUITE 600, WASHINGTON, DC, 20004, US

(21) Appl. No.: 12/073,936

(22) Filed: Mar. 12, 2008

(30) Foreign Application Priority Data
Mar. 20, 2007 (JP) 2007-072824

(51) Int. Cl. G03B 17/00

(52) U.S. Cl. 396/55

(57) ABSTRACT

Problem: To provide a camera which, when subjected to a shock force, is capable of preventing damage to spherical bodies and receiving surfaces thereof for supporting a compensating lens.

Solution Means: The present invention is a camera provided with an image stabilization function, comprising a camera main unit (4), a lens barrel (6) capable of retracting into the camera main unit, a movable portion support surface (12a) disposed inside the lens barrel, a movable portion (14) to which an image blur compensating lens (16) is attached, a plurality of spherical bodies (18) supporting the movable portion such that it can move with respect to the movable portion support surface within a plane perpendicular to an optical axis, a movable portion biasing means (26) for generating a biasing force for causing the movable portion and the movable portion support surface to approach one another and for sandwiching the spherical bodies therebetween, and spherical body protective means (28, 30) which contact the movable portion upon the retraction of the lens barrel into the camera main unit, reducing or removing the pressure sandwiching the spherical bodies.

### TECHNICAL FIELD

The present invention relates to a camera, and more particularly to a camera furnished with an image stabilization function.

Patent JP10-319465 (Patent Document 1) describes a lens shifting device, wherein a movable frame to which a compensating lens is attached is supported by three steel balls so as to be capable of parallel movement; the movable frame is driven by a linear motor to prevent image blur. In lens shifting devices of this type, supporting the movable frame by steel balls enables a moving frame to be driven by a small drive force, with almost no rubbing resistance being produced when the movable frame moves.

### Patent Document 1

JP10-319465

### DISCLOSURE OF THE INVENTION

### Problems to Be Solved by the Invention

In the type of lens shifting device described in JP10-319465, the steel balls (spherical bodies) and the steel ball receiving surfaces contact one another over an extremely small surface area, therefore the problem arises that the receiving surfaces can be easily damaged. That is, when a large shock force acts on a camera equipped with a lens shifting device, such as when the camera is dropped, a shock force based on the inertial force acting on the movable frame or the like acts on the steel balls and the receiving surfaces thereof. This shock force causes a particularly large pressure to be exerted between the small contact surface area steel balls and their receiving surfaces, leading in some cases to plastic deformation of the receiving surfaces and residual fatigue of the steel balls. Fatigue arising on the receiving surfaces causes an increase in the rolling resistance of the steel balls with respect to the receiving surfaces, as well as rapid changes in rolling resistance in the area around the fatigue. Fatigue arising on the receiving surface causes an increase in the rolling resistance of the steel balls with respect to the receiving surface, and suddenly increases the rolling resistance around the fatigue, thus negatively affecting control of the movable frame. Moreover, because the parallelness of the compensating lens attached to the movable frame degrades with the deformation of the receiving surface, the quality of the focused image declines.

Therefore the object of the present invention is to provide a camera capable of preventing damage to the steel balls which support the compensating lens and to the receiving surface thereof when a shock force is imposed.

### Means for Solving the Problems

In order to solve the above-described problems, the present invention is a camera furnished with an image stabilization function, comprising: a camera main body; a lens barrel disposed on the camera main body, capable of retracting into the camera main body; a movable portion support surface disposed within the lens barrel; a movable portion to which an image blur compensating lens is attached; a plurality of spherical bodies supporting the movable portion such that it can move with respect to the movable portion support surface within a plane perpendicular to the optical axis; a biasing means for generating a biasing force for causing the movable portion and the movable portion support surface to approach one another, sandwiching the spherical body between the movable portion and the movable portion support surface; and a spherical body protection means contacting the movable portion when the lens barrel retracts into the camera main body, thereby the pressure sandwiching the spherical body is either reduced or removed.

In the present invention thus constituted, the movable portion to which the image blur compensating lens is attached is supported by a plurality of spherical bodies on a movable portion support surface. The biasing means generates a biasing force causing the movable portion and the movable portion and movable portion support surface to approach one another, and the spherical bodies are sandwiched between those elements. When the lens barrel retracts toward the camera main body, the spherical body protection means contacts the movable portion and reduces or eliminates the pressure sandwiching the spherical bodies.

In the present invention thus constituted, the spherical body protection means reduces or eliminates the pressure sandwiching the spherical bodies, therefore when the lens barrel is retracted into the camera main body, damage to the spherical bodies or their receiving surfaces can be prevented when a shock force acts on the camera.

In the present invention, the spherical body protection means is preferably capable of engaging the movable portion, and the spherical body protection means and the movable portion engage when they come in contact, such that movement of the movable portion within a plane perpendicular to the optical axis is restrained.

In the present invention thus constituted, when the spherical body protection means and the movable portion come into contact, the spherical body protection means and the movable portion engage, and movement within a plane perpendicular to the movable portion optical axis is restrained, thereby protecting the spherical bodies and preventing looseness of the movable portion.

In the present invention, the spherical body protection means preferably comprises a plurality of protective pins disposed so as to be slidable in parallel to the optical axis, and a protective pin biasing spring for respectively biasing these protective pins in a direction away from the movable portion; when the lens barrel retracts into the camera main body, the protective pins are moved in opposition to the protective pin biasing spring biasing force, and the tips thereof contact the movable portion.

In the present invention thus constituted, when the lens barrel is retracted, the protective pins are disposed in a position separated from the movable portion by the biasing force of the protective pin biasing spring; when the lens barrel is retracted into the camera main body, the protective pins are moved against the biasing force of the protective pin biasing spring, and the tips thereof contact the moving portion.

In the present invention, a drop prevention wall is preferably formed around each spherical body, preventing the spherical bodies from falling when the pressure sandwiching the spherical bodies is reduced or eliminated.

In the present invention thus constituted, the provision of a drop prevention wall enables dropping of the spherical bodies to be reliably prevented when the pressure sandwiching the spherical bodies is reduced or eliminated.

In the present invention, the biasing means is preferably a movable portion biasing spring for pulling the movable portion to the movable portion support surface.

In the present invention thus constituted, the movable portion is pulled to the movable portion support surface by the movable portion biasing spring, therefore the pulling force can be maintained even when the movable portion is pulled away from the movable portion support surface.

### EFFECT OF THE INVENTION

In the camera of the present invention, damage can be prevented to the spherical bodies supporting the compensation lens and to the receiving surface thereof when a shock force is applied.

### Best Mode for Practicing the Invention

Next we discuss preferred embodiments of the present invention with reference to the attached figures.

We first discuss a first embodiment of the present invention with reference to FIGS. 1 through 4. FIG. 1 is a cross section showing a camera according to the present embodiment while in use; FIG. 2 is a cross section showing the camera when stored.

As shown in FIGS. 1 and 2, the camera 1 of the first embodiment of the present invention has a lens unit 2 and a camera main body 4. The lens unit 2 has a lens barrel 6, a plurality of imaging lenses 8 disposed within the lens barrel, an actuator 10 for moving an image blur compensation lens 16 among the imaging lenses within a specified plane, and a gyro 34 serving as a vibration detection means for detecting vibration in the camera main body 4.

The lens unit 2 is attached to the camera main body 4, and focuses incoming light on a film surface F.

The lens barrel 6 has a generally cylindrical outer barrel 6a affixed to the camera main body 4, a middle barrel 6b slidably disposed in the axial direction with respect to the outer barrel 6a, and a inner barrel 6c disposed within the center barrel 6b and affixed to the camera main body 4. As shown in FIG. 1, the middle barrel 6b protrudes forward; in the camera stored state, as shown in FIG. 2, the middle barrel 6b retracts into the camera main body 4 and is stored within the outer barrel 6a.

The imaging lenses 8 in the camera 1 of the present embodiment are respectively attached to the middle barrel 6b and the inner barrel 6c; focusing can be accomplished by moving a portion of the imaging lenses 8. The actuator 10 is attached to the middle barrel 6b, and the image blur compensation lens 16 which serves as a portion of the imaging lenses 8 is moved within a plane perpendicular to the optical axis.

In the camera 1 of the present embodiment of the invention, vibration is detected by the gyro 34, the image blur compensation lens 16 is moved by activating the actuator 10 in response to the detected vibration, and images focused on the film surface F within the camera main body 4 are stabilized. In the present embodiment, the image blur compensation lens 16 comprises two lenses, but the lens used to stabilize images may also be a lens group of one or three or more lenses.

Next we discuss the constitution of the actuator 10 with reference to FIGS. 1 through 4. FIG. 3 is a front elevation of the actuator 10 with the moving frame in the image stabilization control operational center position. FIG. 4 is a cross section along line IV-IV in FIG. 3.

As shown in FIGS. 3 and 4, the actuator 10 has a fixed frame 12 which serves as a fixed portion to which the lens barrel 6 middle barrel 6b is affixed, a moving frame 14 serving as a movable portion supported so as to be movable with respect to the fixed frame 12, and three steel balls 18 serving as spherical bodies supporting the moving frame 14.

The actuator 10 is constituted to move the moving frame 14 with respect to the fixed frame 12 affixed to the lens barrel 6 within a plane perpendicular to optical axis, i.e. within a frame parallel to the film surface F. By moving the image blur compensating lens 16 attached to the moving frame 14 in the in-use state shown in FIG. 1, the lens barrel 6 is controlled such that even if vibration occurs, the image focused on the film surface F is not distorted. Meanwhile, the actuator 10 is constituted such that in the stored state shown in FIG. 2, the moving frame 14 is slightly pulled away from the fixed frame 12, and the steel ball 18 receiving surface is protected.

Furthermore, the actuator 10 has two drive coils 20a and 20b attached to the fixed frame 12, and two drive magnets 22a and 22b, respectively attached at positions corresponding to the drive coils 20a and 20b. These drive coils 20a and 20b and the two drive magnets 22a and 22b attached at positions corresponding thereto constitute linear motors, functioning as a drive means for driving the moving frame 14 with respect to the fixed frame 12.

The actuator 10 also has two movable portion biasing springs 26 serving as biasing means for generating a biasing force to cause the moving frame and the moving frame 14 to approach one another.

Furthermore, Hall elements 24a and 24b serving as magnetic sensors are respectively disposed inside the windings in the drive coils 20a and 20b. The Hall elements 24a and 22b detect magnetism in the drive magnets 22a and 22b disposed to respectively face the Hall elements, and they detect the position of the moving frame 14 with respect to the fixed frame 12. The Hall elements 24a and 22b and the drive magnets 22a and 22b constitute a position detection means.

As shown in FIGS. 1 and 2, the actuator 10 has a controller 36 serving as a control means for controlling the current sourced to the drive coils 20a and 20b based on the vibration detected by the gyro 34 and the moving frame 14 position information detected by the Hall elements 24a and 22b.

The fixed frame 12 has a generally cylindrical shape closed at one end, and is inserted into and affixed to the inside of the middle barrel 6b. The end surface of the fixed frame 12 which serves as a movable portion support surface is formed in a donut-shaped disk at the center of which a circular hole is formed. Three drop prevention walls 12b disposed to surround the steel balls 18 are formed at the end surface 12a of the fixed frame 12. These drop prevention walls 12b are formed in a cylindrical shape surrounding the steel balls 18, and are respectively disposed at three locations on a circle centered on the optical axis on the end surface 12a.

The moving frame 14 has a central cylindrical portion 14a and a generally flat donut-shaped flange portion 14b. Two image blur compensation lenses 16 are attached to the cylindrical portion 14a. The flange portion 14b is supported by three steel balls 18 so as to be parallel with the fixed frame 12 end surface 12a.

The steel balls 18, as shown in FIG. 4, are disposed between the fixed frame 12 end surface 12a and the moving frame 14 flange portion 14b. Each of the three steel balls 18 is respectively separated by a center angle of 120° and received within the drop prevention wall 12b formed on the fixed frame 12. Each of the steel balls 18 is also sandwiched between the fixed frame 12 and the moving frame 14 by the biasing force generated by the movable portion biasing spring 26. The moving frame 14 is thus supported on a plane parallel to the fixed frame 12, and movement with respect to the moving frame 14 fixed frame 12 is allowed by the fact that the steel balls 18 roll while being sandwiched in place. Therefore the portion of the end surface 12a surrounded by the drop prevention wall 12b and the portion contacted by each of the steel balls 18 function as receiving surfaces for the steel balls 18.

The two drive coils 20a and 20b are, respectively disposed on the fixed frame 12 end surface 12a. In the present embodiment, the drive coil 20a is disposed above and perpendicular to the optical axis, and the drive coil 20b is disposed with a center angle of 90° with respect to the drive coil 20a. In other words, the drive coils 20a and 20b are respectively disposed on vertical lines and horizontal lines intersecting at the optical axis.

The drive magnets 22a and 22b respectively have an elongated rectangular shape, and are recessed into the moving frame 14. The drive magnets 22a and 22b are arrayed at positions corresponding to the moving frame 14 drive coils 20a and 20b, with the long sides of the elongated rectangles oriented in a direction tangential to a circle centered on the optical axis of the lens unit 2. In this constitution, the flow of current in each of the coils generates a drive force between each coil and its corresponding drive magnet, thereby driving the moving frame 14.

Next we discuss detection of the moving frame 14 position.

At the operational center position of the image blur compensation control the Hall element 24a is disposed so that its sensitivity center point is positioned on the magnetization boundary of the drive magnet 22a. In this case the output signal from the Hall element 24a is zero. The Hall element 24a output signal changes when the drive magnets 22a and 22b move together with the moving frame 14 away from the operational position, and the Hall element 24a sensitivity center point separates from the drive magnets 22a and 22b magnetization boundary line.

When the drive magnet 22a movement of is very small, the Hall element 24a outputs a signal which is essentially proportional to the distance moved by the drive magnet 22a. In the present embodiment, when the distance moved by the drive magnet is within approximately 3% of the length of the long side of the drive magnet 22a, the signal output from the Hall element 24a is essentially proportional to the distance between the Hall element 24a sensitivity center point and the drive magnet 22a magnetization boundary. In the present embodiment the actuator 10, when operating in the image blur compensation control region, operates within a range in which the output of the Hall elements is essentially proportional to the distance moved.

We have discussed the Hall element 24a, but the Hall element 24b also outputs a similar signal based on its positional relationship with the corresponding drive magnet 22b. It is therefore possible to identify the position to which the moving frame 14 has moved with respect to the fixed frame 12 based on the signal detected by the Hall elements 24a and 22b.

We next discuss the spherical body protection means which protects the steel balls 18 and receiving surfaces thereof.

As shown in FIGS. 3 and 4, three protective pins 28 are disposed on the inner circumference of each steel ball 18 at the end surface 12a of the fixed frame 12. The protective pins 28 are slidably arrayed so as to penetrate holes formed in the end surface 12a. A tip end flared portion 28a is formed at the tip side of each protective pin 28, and a base end flared portion 28b is formed at the base end thereof; these flared portions prevent the protective pins 28 penetrating the holes from falling out of the holes. A protective pin biasing spring 30 is also disposed around each protective pin 28. These protective pin biasing springs 30 are respectively disposed between the base end flared portion 28b and the end surface 12a, biasing the protective pins 28 on the camera main body 4 side, i.e. in a direction separating the protective pins 28 from the moving frame 14.

Engaging concavities 14c, positioned to correspond to the protective pins 28, are respectively formed on the moving frame 14 flange portion 14b. Each engaging concavity 14c is formed to receive the tip end flared portion 28a on each protective pin 28 without gaps.

In the camera 1 in-use state, as shown in FIG. 1, each protective pin 28 is maintained in a retracted state, whereas in the camera 1 stored state, as shown in FIG. 2, each protective pin 28 is projected outward, contacting the moving frame 14. The outward projection of each protective pin 28 causes the moving frame 14 to be pulled away from the fixed frame 12 end surface 12a. As discussed below, the protective pins 28 and the protective pin biasing springs 30 function as spherical body protection means.

Next we discuss the operation of the actuator 10 built into the camera 1 of the present embodiment. First, image stabilization control is executed in the camera 1 in-use state. Camera 1 vibration is continuously detected by the gyro 34 and input to the controller 36. In the present embodiment, the gyro 34 is constituted to respectively detect the angular velocities of the camera 1 yawing and pitching motions.

The controller 36 performs a continuous time integration of the angular speed input from the gyro 34, generating a lens position command signal horizontal component Dx and vertical component Dy by performing a predetermined optical characteristic compensation. Current is sourced to each of the drive coils 20a and 20b in accordance with the lens position command signals thus obtained, thereby driving the moving frame 14 and continuously moving the image blur compensation lens 16 attached thereto. The image focused on the film surface F in the camera main body 4 is thus stabilized without distortion even if the lens unit vibrates during photographic exposure.

Next we discuss the operation of the camera 1 of the present embodiment when changing from the in-use state to the stored state.

As shown in FIG. 1, in the camera 1 in-use state each protective pin 28 is maintained in a state whereby the tip end flared portion 28a is in contact with the end surface 12a of the fixed frame 12, i.e. in the retracted state. In that state, the tip end flared portion 28a of each protective pin 28 does not contact the moving frame 14, and is separated therefrom. The moving frame 14 is therefore biased by the movable portion biasing spring 26 so that it approaches the end surface 12a of the fixed frame 12. The steel balls 18 are sandwiched between the moving frame 14 flange portion 14b and the fixed frame 12 end surface 12a by this biasing force.

Next, when the camera 1 power switch (not shown) is turned off, the camera 1 shifts to the stored state. That is, when the power switch (not shown) is turned off, the lens barrel 6 middle barrel 6b is retracted into the camera main body 4. When the middle barrel 6b moves into the camera main body 4, the base end flared portions 28b of each protective pin 28 contact the tip of the inner barrel 6c and are pushed in. This causes the protective pin biasing springs 30 disposed around each protective pin 28 to be compressed, and each protective pin 28 to be moved in opposition to the protective pin biasing spring 30 biasing force, projecting outward toward the moving frame 14.

When the lens barrel 6 middle barrel 6b is moved to the camera 1 stored state as shown in FIG. 2, the tip end flared portions 28a of each protective pin 28 contact the engaging concavities 14c formed on the moving frame 14 flange portion 14b, and the moving frame 14 is pushed so as to move away from the fixed frame 12 end surface 12a. This causes the pressure sandwiching the steel balls 18 between the flange portion 14b and the end surface 12a to be reduced to zero. The tip end flared portion 28a on each protective pin 28 is received into each engaging concavity 14c without gaps and engaged. Therefore in the state in which the tip end flared portions 28a are received in each of the engaging concavities 14c, movement of the moving frame 14 within the plane perpendicular to the optical axis is restrained.

Even in this state in which the moving frame 14 is moved and separated from the end surface 12a, the steel balls 18 are kept on the inside of the drop prevention wall 12b, since the gap between the drop prevention wall 12b and the flange portion 14b is smaller than the diameter of the steel balls 18. Therefore the steel balls 18 are disposed in the space surrounded by the drop prevention wall 12b and the flange portion 14b, so that the steel balls 18 are capable of freely moving within this space.

When a shock force acts on the camera 1 in this state, the steel balls 18 move within the space, colliding with the inner wall surface of the drop prevention wall 12b or the surface of the flange portion 14b. The shock force applied to the flange portion 14b surface or the like in such a collision results solely from the inertial force acting on the steel balls 18. Since the mass of the steel balls 18 is extremely small, the shock force acting on the of the flange portion 14b surface or the like is also extremely small. Damage to steel ball 18 receiving surfaces such as the flange portion 14b surface is thereby prevented.

Next, when the power switch (not shown) is turned on and the camera 1 shifts into the in-use state, the lens barrel 6 middle barrel 6b moves so as to project outward from the camera main body 4. By this means the protective pin 28 base end flared portion 28b separates from the inner barrel 6c, and the protective pins 28 are moved into the camera main body 4 by the protective pin biasing spring 30 biasing force. When the protective pins 28 are moved, the tip end flared portions 28a thereof separate from the moving frame 14 and steel balls 18 are once again sandwiched between the fixed frame 12 and the moving frame 14 by the movable portion biasing spring 26 biasing force.

According to the first embodiment of the present invention, the pressure by which the protective pins retain the steel balls is removed when the lens barrel retracts into the camera main body, therefore when a shock acts on the camera, damage to the steel balls or the receiving surfaces thereof can be prevented.

According to the camera of the present embodiment, the protective pin tips are received in the moving frame engaging concavities when the protective pins and the moving frame come into contact, therefore moving frame looseness can be prevented.

Furthermore, according to the camera of the present embodiment, a drop prevention wall is provided around the steel balls, therefore steel balls can be reliably prevented from dropping when the pressure sandwiching the steel balls is removed.

In the camera of the present embodiment, the movable portion is pulled onto the tip surface of the fixed frame by the movable portion biasing spring; therefore the pulling force can be maintained even when the moving frame is pulled away from the end surface.

Moreover, in the camera of the present embodiment the steel balls are placed in a freely moving state when the pressure by which the protective pins sandwich the steel balls is removed, therefore the location at which steel balls make contact with the moving frame and the fixed frame varies randomly. This makes it possible to prevent partial wear in which only certain parts of the steel balls are subjected to wear.

In the first embodiment of the present invention described above, dropping of the steel balls was prevented by the drop prevention wall, but as a variation it is also possible to attach a magnet for holding the steel balls to a fixed frame or a moving frame, thereby preventing the steel balls from falling.

Furthermore, in the present embodiment of the present invention described above, the moving frame was pulled to the fixed frame by a movable portion biasing spring, but as a variation the moving frame could be held to the fixed frame using an affixing magnet.

Next, referring to FIGS. 5 and 6, we discuss a camera according to a second embodiment of the present invention. The camera of the present embodiment differs from the first embodiment described above in that the protective pins are provided on the inner barrel of the lens barrel. Therefore only the points in the present embodiment which differ from the first embodiment are discussed; shared features are assigned the same reference numerals and omitted from the discussion. FIG. 5 is a cross section of a camera according to the present embodiment in the in-use state; FIG. 6 is a cross section in the stored state.

As shown in FIGS. 5 and 6, a camera 100 of the second embodiment of the present invention has a lens unit 2 and a camera main body 4. The lens unit 2 has a lens barrel 6, a plurality of imaging lenses 8, a image blur compensation lens 16, an actuator 10, and a gyro 34.

The lens barrel 6 has an outer barrel 6a, a slidably disposed middle barrel 6b, and an inner barrel 6c affixed to the camera main body 4.

The actuator 10 has a fixed frame 12 serving as a fixed portion affixed to the lens barrel 6 middle barrel 6b, a moving frame 14 serving as a movable portion, and three steel balls 18 serving as spherical bodies.

Furthermore, the actuator 10 has two drive coils 20a and 20b and two drive magnets 22a and 22b attached to the moving frame 14. The actuator 10 also has two movable portion biasing springs 26 serving as biasing means for generating a biasing force to cause the moving frame 14 and the fixed frame 12 to approach one another. Hall elements 24a and 24b serving as magnetic sensors are respectively disposed on the inside of the drive coil 20a and 20b windings. The actuator 10 has a controller 36 serving as a control means for controlling the current sent to the drive coils 20a and 20b. The actuator 10 has a controller 36 serving as a control means for controlling the current sourced to the drive coils 20a and 20b.

The fixed frame 12 is inserted into and affixed on the inside of the middle barrel 6b. Three cylindrical drop prevention walls 12b are formed on the fixed frame 12 end surface 12a. The moving frame 14 has a central cylindrical portion 14a and a flange portion 14b.

We next discuss the spherical body protection means which protect the steel balls 18 and the receiving surfaces thereof.

As shown in FIGS. 5 and 6, three protective pins 128 (only one of which is depicted in FIGS. 5 and 6) serving as spherical body protection means are disposed at the end surface of the inner barrel 6c so as to project outward toward the front of the camera 100. These protective pins 128 are disposed at equal 120° center angle intervals on a circle centered on the optical axis of the lens unit 2, and extend in the optical axis direction. Meanwhile, through-holes 112 are respectively disposed at fixed frame 12 end surface 12a in positions corresponding to each of the protective pins 128.

In the camera 100 in-use state, as shown in FIG. 5, the protective pins 128 are in a position separated from the fixed frame 12. At the same time, when the camera 100 changes over to the stored state, the protective pins 128, as shown in FIG. 6, penetrate the through-holes 112 formed on the fixed frame 12 end surface 12a, and the tips thereof are brought into contact with the moving frame 14. The moving frame 14 is separated from the fixed frame 12 end surface 12a by contact with the protective pins 128 which have penetrated the end surface 12a. This causes the pressure sandwiching the steel balls 18 to be reduced to zero.

In the camera according to the second embodiment of the present invention, the pressure sandwiching the steel balls is removed by the protective pins disposed at the end surface of the inner barrel, therefore the steel balls and the receiving surfaces thereof can be protected by a simple mechanism.

We have discussed preferred embodiments of the present invention, but a number of variations can be added to the embodiments described above. In particular, in the above-described embodiments the present invention was applied to film cameras, but the present invention can also be freely applied to still or moving image capture cameras such as digital cameras, video cameras, and the like.

In the above-described embodiments the pressure sandwiching the steel balls was released when the camera was placed in the stored state, but the pressure sandwiching the steel balls could also be released in any desired state in addition to the stored state.

Moreover, in the embodiments described above the drop prevention wall was formed in a fixed frame, but a drop prevention wall could also be formed in the moving frame. Also, in the embodiments described above the drop prevention wall comprised a cylindrical wall projecting outward from the fixed frame, but concavities could also be formed on the fixed frame and/or the moving frame, and the side surfaces inside the concavities used as drop prevention walls.

Furthermore, in the above-described embodiments the steel balls and the receiving surfaces thereof were protected by removing the sandwiching pressure on the steel balls, but it is also sufficient to reduce the sandwiching pressure. That is, by setting the outward projection position of the protective pins in the stored state or the like such that the tips thereof contact the moving frame, and such that the moving frame is not pulled away from the fixed frame, it becomes possible to reduce the pressure sandwiching the steel balls while still retaining the steel balls between the moving frame and the fixed frame. Alternatively, the sandwiching pressure on the steel balls can also be reduced by causing the tips of the protective pins to be elastically pressed onto the moving frame.

### BRIEF DESCRIPTION OF FIGURES

FIG. 1 A cross section of a camera in the in-use state according to a first embodiment of the present invention.

FIG. 2 A cross section of a camera in the stored state according to a first embodiment of the present invention.

FIG. 3 A front elevation of an actuator in which a moving frame is in the image stabilization control operational center position.

FIG. 4 A side elevation cross section along line IV-IV of FIG. 3.

FIG. 5 A cross section of a camera in the in-use state according to a second embodiment of the present invention.

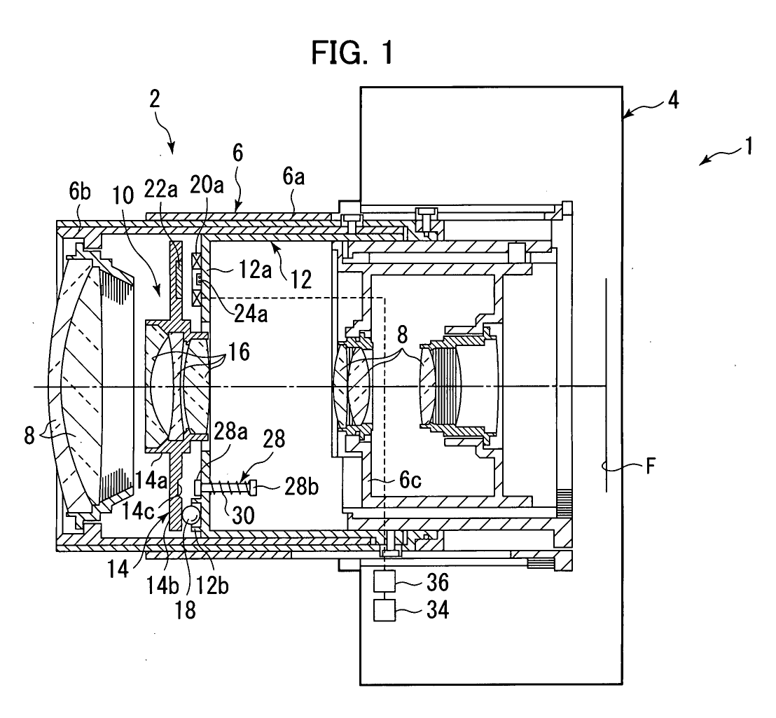

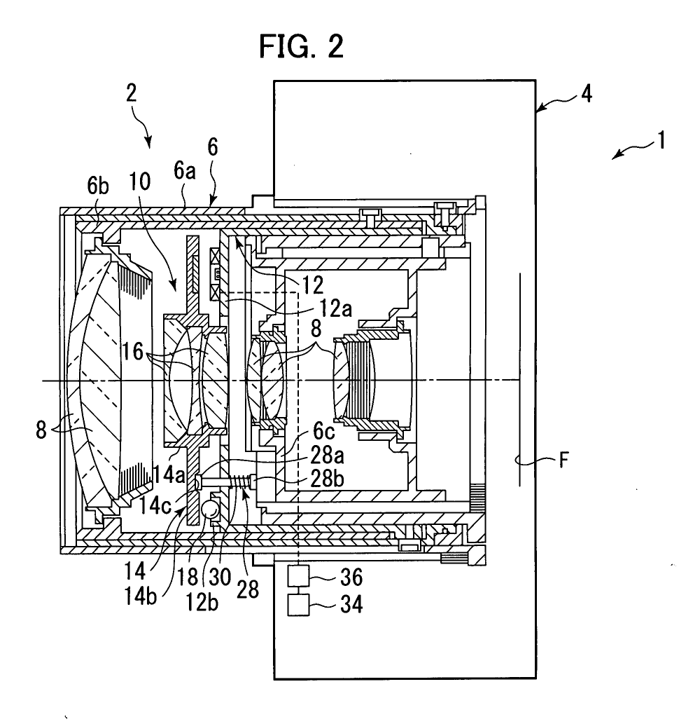

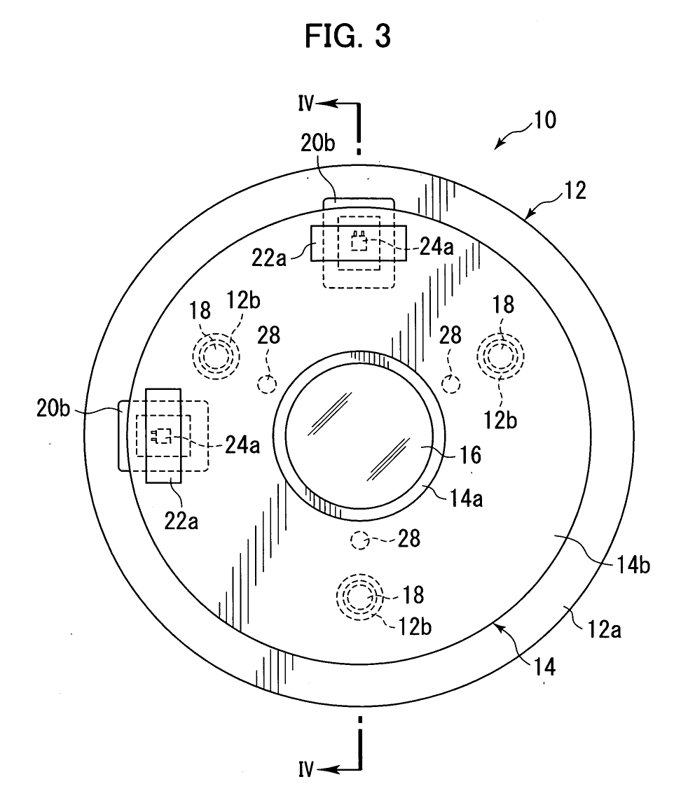

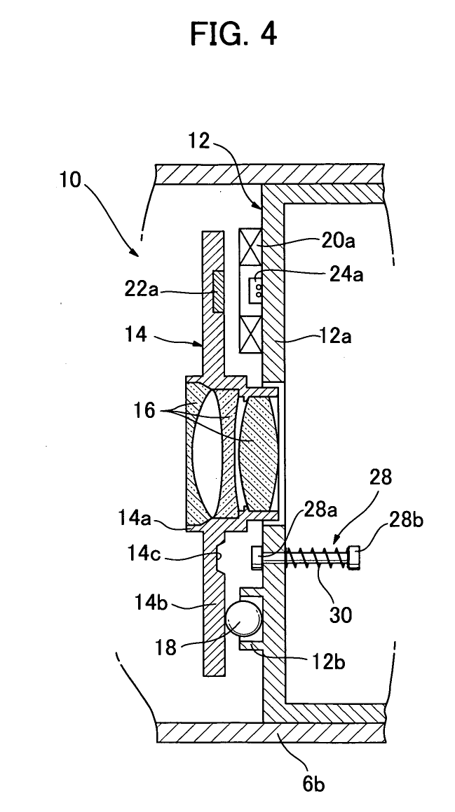

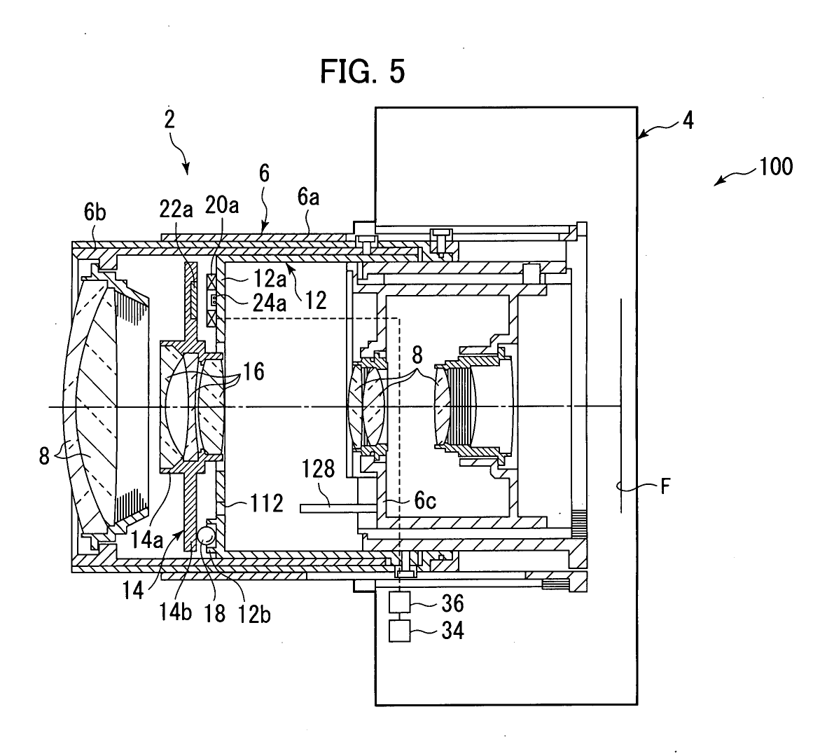

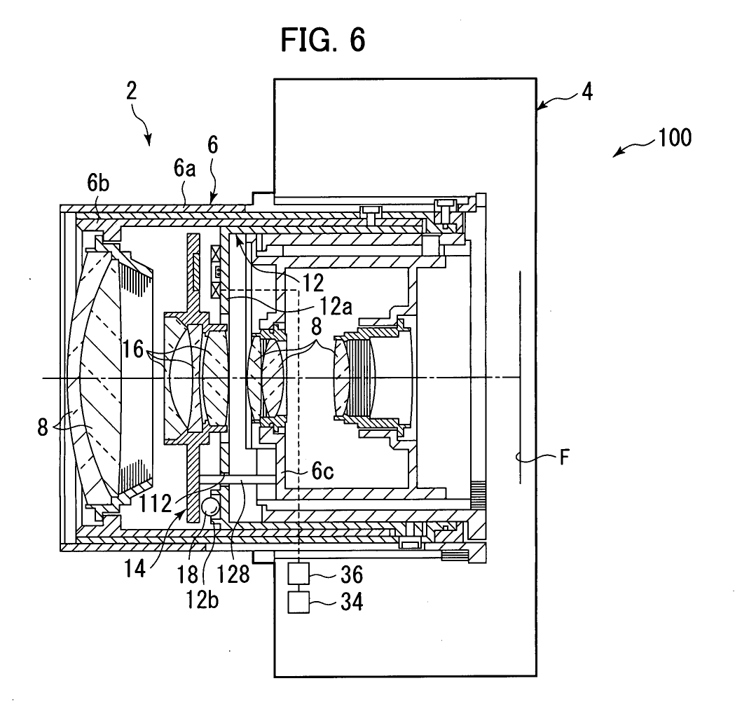

FIG. 6 A cross section of a camera in the stored state according to a second embodiment of the present invention.
1 First embodiment camera of the present invention
2 Lens unit
4 Camera main body
6 Lens barrel
6a Outer barrel
6b Middle barrel
6c Inner barrel
8 Imaging lens
10 Actuator
12 Fixed frame
12a a End surface (movable portion support surface)
12b b Drop prevention wall
14 Moving frame (movable portion)
14a Cylindrical portion
14b Flange portion
14c Engaging concavity
16 Image blur compensating lens
18 Steel balls (spherical bodies)
20a, 20b Drive coils
22a, 22b Drive magnets
24a, 24b Hall elements
26 Movable portion biasing spring (biasing means)
28 Protective pins
28a Tip end flared portion
28b Base end flared portion
30 Protective pin biasing spring
34 Gyro
100 Second embodiment camera of the present invention
112 Through-holes 112
128 Protective pins (spherical body protection means)

1. A camera furnished with an image stabilization function, comprising:
a camera main body;
a lens barrel disposed on the camera main body, capable of retracting into the camera main body;
a movable portion support surface disposed within the lens barrel;
a movable portion to which an image blur compensating lens is attached;
a plurality of spherical bodies supporting the movable portion such that it can move with respect to the movable portion support surface within a plane perpendicular to the optical axis;
a biasing means for generating a biasing force for causing the movable portion and the movable portion support surface to approach one another, sandwiching the spherical body between the movable portion and the movable portion support surface; and
a spherical body protection means contacting the movable portion when the lens barrel retracts into the camera main body, thereby the pressure sandwiching the spherical body is either reduced or removed.

2. The camera according to claim 1, wherein the spherical body protection means is capable of engaging the movable portion, and when the spherical body protection means and the movable portion come in contact, the spherical body protection means and the movable portion engage, such that movement of the movable portion within a plane perpendicular to the optical axis is restrained.

3. The camera according to claim 1, wherein the spherical body protection means comprises a plurality of protective pins disposed so as to be slidable in parallel to the optical axis, and protective pin biasing springs respectively biasing these protective pins in a direction away from the movable portion, such that retraction of the lens barrel into the camera main body causes the protective pins to move in opposition to the protective pin biasing spring biasing force, and the tip of the protective pins contact the movable portion.

4. The camera according to claim 1, having a drop prevention wall formed on the perimeter of the spherical body, such the spherical body is prevented from falling when the pressure retaining the spherical body is reduced or eliminated.

5. The camera according to claim 1, in which the biasing means is a movable portion biasing spring for pulling in the movable portion to the movable portion support surface.
